(19) United States
(12) Patent Application Publication
(10) Pub. No.: US 2025/0331467 A1
(43) Pub. Date: Oct. 30, 2025

(54) BALE WRAP ASSEMBLY TRANSPORT SYSTEM FOR AN AGRICULTURAL HARVESTER

(71) Applicant: CNH Industrial America LLC, New Holland, PA (US)

(72) Inventors: Daniel Dallman, Eldridge, IA (US); Francisco Rivera, Leola, PA (US); Bogdan Apetroaei, Brasov (RO); Marius Cristian Simion, Iasi (RO)

(21) Appl. No.: 19/195,088

(22) Filed: Apr. 30, 2025

Related U.S. Application Data
(60) Provisional application No. 63/640,274, filed on Apr. 30, 2024.

(51) Int. Cl. A01F 15/07

(52) U.S. Cl. CPC A01F 15/0715

(57) ABSTRACT

A bale wrap assembly transport system for an agricultural harvester includes a base configured to couple to a component of the agricultural harvester. The bale wrap assembly transport system also includes an arm assembly slidably coupled to the base and configured to move with respect to a lateral axis of the agricultural harvester between a retracted position and an extended position. Furthermore, the bale wrap assembly transport system includes a clamp assembly configured to selectively couple to a bale wrap assembly, and the bale wrap assembly transport system includes a winch assembly coupled to the arm assembly and to the clamp assembly. The winch assembly is configured to lower the clamp assembly to a first lowered position while the arm assembly is in the extended position to enable the clamp assembly to couple to the bale wrap assembly.

### CROSS-REFERENCE TO RELATED APPLICATION

This application claims priority from and the benefit of U.S. Provisional Application Ser. No. 63/640,274, entitled “BALE WRAP ASSEMBLY TRANSPORT SYSTEM FOR AN AGRICULTURAL HARVESTER”, filed Apr. 30, 2024, which is hereby incorporated by reference in its entirety.

### BACKGROUND

The present disclosure relates generally to a bale wrap assembly transport system for an agricultural harvester.

Agricultural harvesters are used to harvest agricultural products (e.g., cotton or other natural material(s)). For example, an agricultural harvester may include a header having drums configured to harvest the agricultural product from a field. The agricultural harvester may also include an air-assisted conveying system configured to move the agricultural product from the drums to an accumulator. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

### BRIEF DESCRIPTION

In certain embodiments, a bale wrap assembly transport system for an agricultural harvester includes a base configured to couple to a component of the agricultural harvester. The bale wrap assembly transport system also includes an arm assembly slidably coupled to the base and configured to move with respect to a lateral axis of the agricultural harvester between a retracted position and an extended position. Furthermore, the bale wrap assembly transport system includes a clamp assembly configured to selectively couple to a bale wrap assembly, and the bale wrap assembly transport system includes a winch assembly coupled to the arm assembly and to the clamp assembly. The winch assembly is configured to lower the clamp assembly to a first lowered position while the arm assembly is in the extended position to enable the clamp assembly to couple to the bale wrap assembly, to raise the clamp assembly to a raised position while the arm assembly is in the extended position and the clamp assembly is coupled to the bale wrap assembly, and to lower the clamp assembly to a second lowered position while the arm assembly is in the retracted position to enable the clamp assembly to release the bale wrap assembly at a desired location within the agricultural harvester.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural machine system having an agricultural product transport assembly and a baler;

FIG. 2 is a schematic view of an embodiment of an agricultural product transport assembly and an embodiment of a baler that may be employed within the agricultural machine system of FIG. 1;

FIG. 3 is a perspective view of an embodiment of a bale wrap assembly transport system that may be employed within the agricultural machine system of FIG. 1, in which an arm assembly of the bale wrap assembly transport system is in an extended position;

FIG. 4 is a perspective view of the bale wrap assembly transport system of FIG. 3;

FIG. 5 is a front view of a portion of the bale wrap assembly transport system of FIG. 3;

FIG. 6 is a front view of a portion of the bale wrap assembly transport system of FIG. 3;

FIG. 7 is a perspective view of a portion of the bale wrap assembly transport system of FIG. 3;

FIG. 8A is a perspective view of a portion of the bale wrap assembly transport system of FIG. 3, in which a clamp assembly of the bale wrap assembly transport system is in a released state;

FIG. 8B is a perspective view of a portion of the bale wrap assembly transport system of FIG. 3, in which the clamp assembly is in a coupled state;

FIG. 9A is a perspective view of the bale wrap assembly transport system of FIG. 3, in which the arm assembly is in the extended position, and the clamp assembly is in a first lowered position;

FIG. 9B is a perspective view of the bale wrap assembly transport system of FIG. 3, in which the arm assembly is in the extended position, and the clamp assembly is in a raised position; and

FIG. 9C is a perspective view of the bale wrap assembly transport system of FIG. 3, in which the arm assembly is in a retracted position, and the clamp assembly is in a second lowered position.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

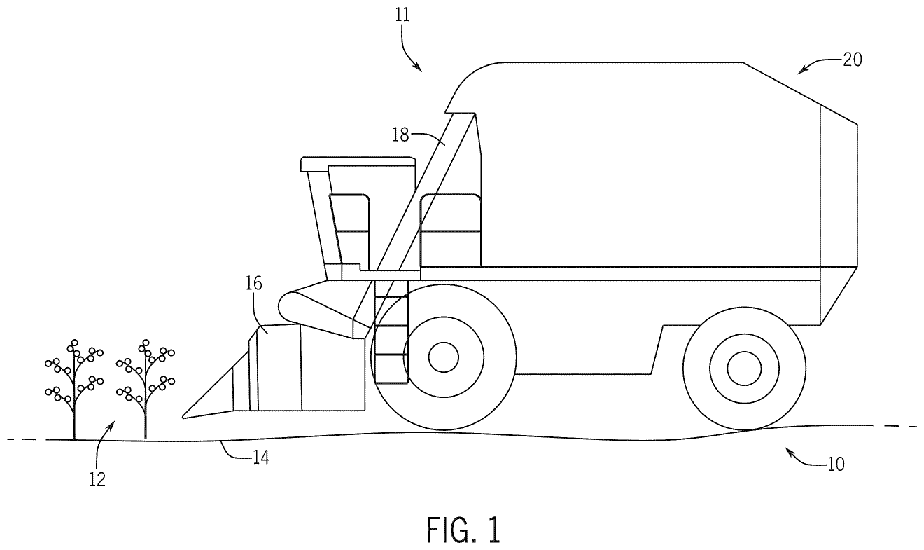

FIG. 1 is a side view of an embodiment of an agricultural machine system 10 (e.g., harvester, agricultural harvester) having an agricultural product transport assembly 11 and a baler. The agricultural machine system 10 is configured to harvest agricultural product 12 (e.g., cotton) from a field 14 and to form the agricultural product 12 into bales (e.g., agricultural bales). In the illustrated embodiment, the agricultural machine system 10 includes a header 16 having drums configured to harvest the agricultural product 12 from the field 14. Additionally, the agricultural product transport assembly 11 of the agricultural machine system 10 includes an air-assisted conveying system 18 configured to move the agricultural product 12 from the drums of the header 16 to an accumulator assembly of the agricultural product transport assembly 11. The agricultural product transport assembly 11 also includes a conveying system configured to convey the agricultural product 12 from the accumulator assembly into the baler 20 (e.g., agricultural baler). The baler 20 is supported by and/or mounted within or on a chassis of the agricultural machine system 10. The baler 20 may form the agricultural product 12 into round bales. However, in other embodiments, the baler 20 of the agricultural machine system 10 may form the agricultural product into square bales, polygonal bales, or bales of other suitable shape(s). After forming the agricultural product 12 into a bale, a bale wrapping system of the agricultural machine system 10 wraps the bale with a bale wrap to secure the agricultural product 12 within the bale and to generally maintain a shape of the bale.

As discussed in detail below, the agricultural machine system 10 includes a bale wrap assembly transport system configured to move a bale wrap assembly into a bale wrap assembly storage compartment. A bale wrap feeding assembly receives the bale wrap assembly from the bale wrap assembly storage compartment and feeds the bale wrap of the bale wrap assembly toward the bale. The bale wrap assembly transport system includes a base configured to couple to the bale wrap assembly storage compartment. The bale wrap assembly transport system also includes an arm assembly slidably coupled to the base and configured to move with respect to a lateral axis of the agricultural machine system 10 between a retracted position and an extended position. Furthermore, the bale wrap assembly transport system includes a clamp assembly configured to selectively couple to the bale wrap assembly, and the bale wrap assembly transport system includes a winch assembly coupled to the arm assembly and to the clamp assembly. The winch assembly is configured to lower the clamp assembly to a first lowered position while the arm assembly is in the extended position to enable the clamp assembly to couple to the bale wrap assembly, to raise the clamp assembly to a raised position while the arm assembly is in the extended position and the clamp assembly is coupled to the bale wrap assembly, and to lower the clamp assembly to a second lowered position while the arm assembly is in the retracted position to enable the clamp assembly to release the bale wrap assembly within the bale wrap assembly storage compartment. The bale wrap assembly transport system enables the bale wrap assembly to be moved from a position external to the storage compartment (e.g., on the ground, on a vehicle, on a pallet, etc.) to the storage compartment by a single operator. As a result, the time associated with disposing the bale wrap assembly within the storage compartment may be significantly reduced (e.g., as compared to employing the assistance of a second operator to manually lift and move the bale wrap assembly to the storage compartment).

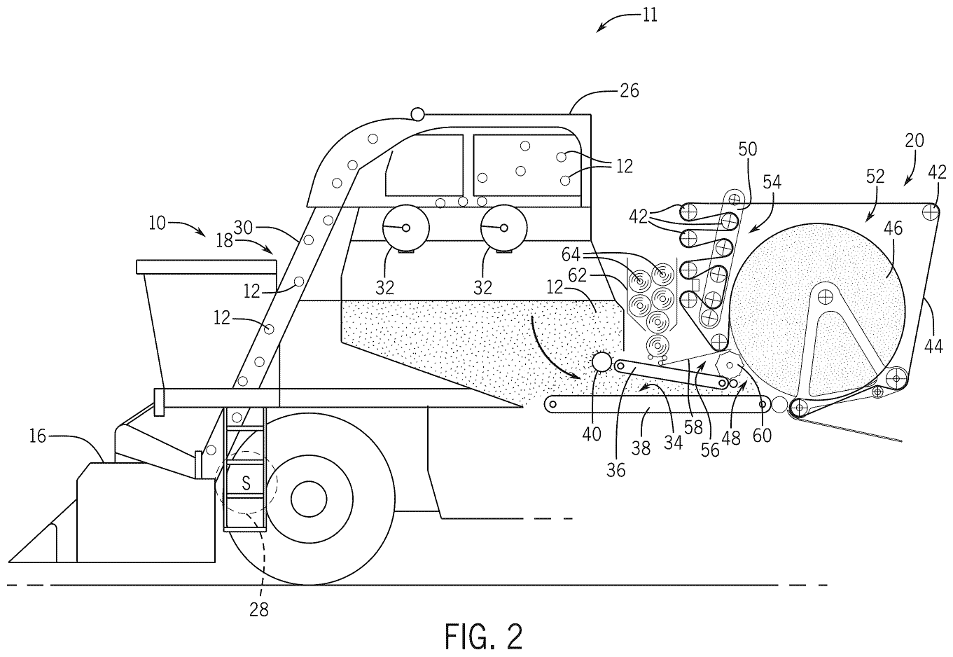

FIG. 2 is a schematic view of an embodiment of an agricultural product transport assembly 11 and an embodiment of a baler 20 that may be employed within the agricultural machine system 10 of FIG. 1. As previously discussed, the header 16 of the agricultural machine system 10 includes drums configured to harvest the agricultural product 12 (e.g., cotton) from the field. Furthermore, the air-assisted conveying system 18 is configured to move the agricultural product 12 from the drums of the header 16 to the accumulator assembly 26. In the illustrated embodiment, the air-assisted conveying system 18 includes a conveying air source 28 configured to output a conveying air flow through one or more ducts 30. Each duct 30 receives the agricultural product 12 (e.g., cotton) from the header 16, and the conveying air flow output by the conveying air source 28 drives the agricultural product to move through the duct(s) 30 from the header 16 to the accumulator assembly 26. In the illustrated embodiment, the agricultural product transport assembly 11 includes augers 32 configured to distribute the agricultural product 12 (e.g., cotton) laterally across the accumulator assembly 26 (e.g., crosswise to the downward movement of the agricultural product through the accumulator assembly). In the illustrated embodiment, the agricultural product transport assembly 11 includes two augers 32. However, in other embodiments, the agricultural product transport assembly may include more or fewer augers (e.g., 0, 1, 3, 4, or more).

In the illustrated embodiment, the conveying system 34 of the agricultural product transport system 11 includes a first belt (e.g., belt) 36 configured to move the agricultural product 12 from the accumulator assembly 26 to the baler 20. The first belt 36 is configured to rotate in a first rotational direction to move an agricultural product engaging surface of the first belt 36 toward the baler 20. Furthermore, in the illustrated embodiment, the conveying system 34 includes a second belt 38 positioned on an opposite side of the agricultural product 12 from the first belt 36, and the second belt 38 is configured to cooperate with the first belt 36 to move the agricultural product 12 from the accumulator assembly 26 to the baler 20. Furthermore, in the illustrated embodiment, the conveying system 34 includes an agitation roller 40 positioned upstream of the first belt 36. The agitation roller 40 is configured to agitate the agricultural product 12 entering the pair of opposing belts, thereby enhancing the uniformity of the distribution of the agricultural product passing through the pair of opposing belts.

In the illustrated embodiment, the baler 20 includes multiple rollers 42 that support and/or drive rotation of one or more belts 44. For example, one or more rollers 42 engage the belt(s) 44, which enable the belt(s) 44 to move along the pathway defined by the rollers 42 and the bale 46. One or more rollers 42 are driven to rotate via a belt drive system (e.g., including electric motor(s), hydraulic motor(s), pneumatic motor(s), etc.). The belt(s) 44 circulate around the pathway defined by the rollers 42 and the bale 46. Movement of the belt(s) 44 captures agricultural product 12 from the conveying system 34 and draws the agricultural product 12 into a cavity 48, where the agricultural product 12 is gradually built up to form the bale 46.

In the illustrated embodiment, the baler 20 includes a tension arm 50 configured to establish tension within the belt(s) 44. As the agricultural product 12 builds within the cavity 48, the agricultural product 12 applies a force to the belt(s) 44 that urges a first portion 52 of the belt(s) 44 surrounding the bale 46 to expand. Concurrently, the size of a second portion 54 (e.g., serpentine portion) of the belt(s) 44 is reduced. Accordingly, the second portion 54 of the belt(s) 44 provides the increasing belt length for the expanding first portion 52. In the illustrated embodiment, the second portion 54 of the belt(s) 44 is established by fixed rollers 42 (e.g., rollers fixed to a housing/frame of the baler 20) and rollers 42 coupled to the tension arm 50, which is pivotable relative to the fixed rollers 42 (e.g., relative to the housing/frame of the baler 20). Accordingly, as the agricultural product 12 builds within the cavity 48, the tension arm 50 is driven to rotate, thereby reducing the size of the second portion 54 and enabling the first portion 52 to expand.

Once the bale 46 reaches a desired size, a bale wrapping system 56 wraps the bale 46 with a bale wrap 58 to secure the agricultural product within the bale 46 and to generally maintain a shape of the bale 46, such as the round shape in the illustrated embodiment. In other embodiments, the shape of the bale may be rectangular, polygonal, or another suitable shape. The bale wrap 58 may be fed into contact with the bale 46 using one or more feed rollers. The feed rollers drive the bale wrap 58 toward a starter roller 60. The starter roller 60 is configured to rotate to drive the bale wrap 58 into contact with the bale 46. The bale wrap 58 is captured between the bale 46 and the belt(s) 44. Accordingly, rotation of the bale 46 draws the bale wrap 58 around the bale 46, thereby wrapping the bale 46. After the bale 46 is wrapped, the bale 46 is ejected from the baler 20, and the process of forming a subsequent bale may be initiated.

In certain embodiments, during the harvesting process, the conveying system 34 and the baler 20 may be periodically activated to transfer the agricultural product 12 from the accumulator assembly 26 to the baler 20 and to form the bale 46. For example, as the agricultural machine system 10 traverses a field, the agricultural product 12 may accumulate within the accumulator assembly 26. After a selected duration, the conveying system 34 may be activated to transfer the agricultural product 12 from the accumulator assembly 26 to the baler 20. For example, the conveying system 34 may move the agricultural product 12 toward the baler 20 at a significantly faster rate than the air-assisted conveying system 18 moves the agricultural product 12 into the accumulator assembly 26. Concurrently with activation of the conveying system 34, the baler 20 may be activated to initiate the bale forming process, as described above. After another selected duration, the conveying system 34 and the baler 20 may be deactivated to enable the accumulator assembly 26 to collect additional agricultural product 12. In certain embodiments, the conveying assembly 34 and the baler 20 may be activated four or five times to enable the bale 46 to reach the desired size. As previously discussed, once the bale reaches the desired size, the bale wrapping system 56 wraps the bale 46 with the bale wrap 58. Because the conveying system 34 and the baler 20 are periodically activated, the agricultural machine system 10 may utilize less energy during the harvesting process (e.g., as compared to continuously operating the conveying system and the baler).

In the illustrated embodiment, the agricultural machine system 10 includes a bale wrap assembly storage compartment 62 configured to store multiple bale wrap assemblies 64. In certain embodiments, each bale wrap assembly 64 includes a shaft and a bale wrap disposed about the shaft to form a roll of the bale wrap. However, in other embodiments, the shaft may be omitted, and the bale wrap may be arranged in a roll (e.g., with a hollow region at the center).

Furthermore, as discussed in detail below, the agricultural machine system 10 includes a bale wrap assembly transport system configured to move each bale wrap assembly 64 into the bale wrap assembly storage compartment 62. The bale wrap assembly transport system includes a base coupled to the bale wrap assembly storage compartment 62. The bale wrap assembly transport system also includes an arm assembly slidably coupled to the base and configured to move with respect to a lateral axis of the agricultural machine system 10 between a retracted position and an extended position. Furthermore, the bale wrap assembly transport system includes a clamp assembly configured to selectively couple to the bale wrap assembly 64, and the bale wrap assembly transport system includes a winch assembly coupled to the arm assembly and to the clamp assembly. The winch assembly is configured to lower the clamp assembly to a first lowered position while the arm assembly is in the extended position to enable the clamp assembly to couple to the bale wrap assembly 64, to raise the clamp assembly to a raised position while the arm assembly is in the extended position and the clamp assembly is coupled to the bale wrap assembly 64, and to lower the clamp assembly to a second lowered position while the arm assembly is in the retracted position to enable the clamp assembly to release the bale wrap assembly 64 within the bale wrap assembly storage compartment 62. The bale wrap assembly transport system enables the bale wrap assembly to be moved from a position external to the storage compartment (e.g., on the ground, on a vehicle, on a pallet, etc.) to the storage compartment 62 by a single operator. As a result, the time associated with disposing the bale wrap assembly within the storage compartment may be significantly reduced (e.g., as compared to employing the assistance of a second operator to manually lift and move the bale wrap assembly to the storage compartment).

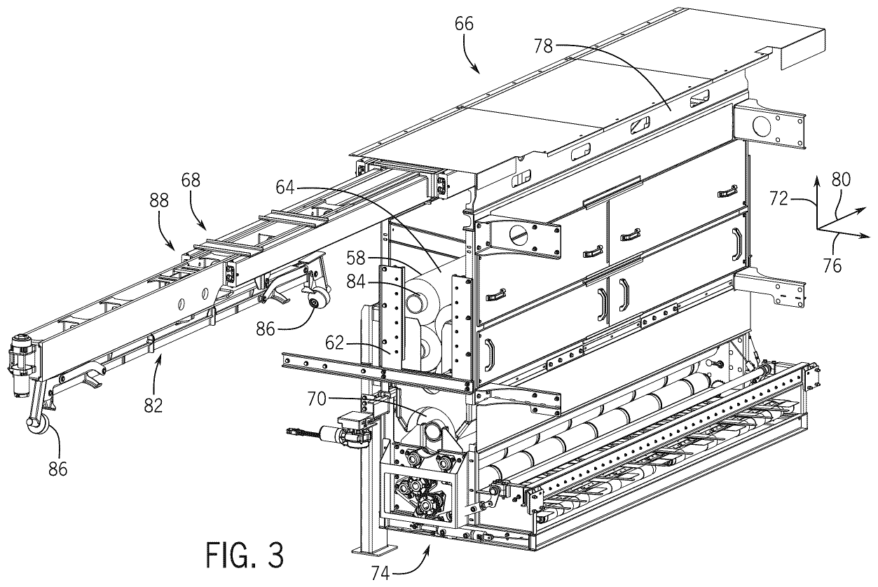

FIG. 3 is a perspective view of an embodiment of a bale wrap assembly transport system 66 that may be employed within the agricultural machine system of FIG. 1, in which an arm assembly 68 of the bale wrap assembly transport system 66 is in an extended position. As previously discussed, the bale wrap assembly storage compartment 62 is configured to store multiple bale wrap assemblies 64. In addition, the bale wrap assembly storage compartment 62 is configured to feed an active bale wrap assembly 70 downwardly with respect to a vertical axis 72 of the agricultural machine system to a bale wrap feeding assembly 74. The bale wrap feeding assembly 74 is configured to receive the active bale wrap assembly 70 from the bale wrap assembly storage compartment 62, and the bale wrap feeding assembly 74 is configured to feed the bale wrap of the active bale wrap assembly 70 toward the bale with respect to a longitudinal axis 76 of the agricultural machine system.

Furthermore, the bale wrap assembly transport system 66 is configured to move each bale wrap assembly 64 into the bale wrap assembly storage compartment 62. The bale wrap assembly transport system 66 includes a base 78 coupled to the bale wrap assembly storage compartment 62 (e.g., component of the agricultural harvester). The base 78 may be coupled to the bale wrap assembly storage compartment 62 (e.g., to a frame of the bale wrap assembly storage compartment 62) by any suitable type(s) of connection(s) (e.g., a welded connection, a fastener connection, a latched connection, an adhesive connection, other suitable type(s) of connection(s), or a combination thereof). Furthermore, in certain embodiments, the base may be integrally coupled to (e.g., integrally formed with) the bale wrap assembly storage compartment 62. In addition, while the base 78 is coupled to the bale wrap assembly storage compartment 62 in the illustrated embodiment, in other embodiments, the base may be coupled to another suitable component of the agricultural machine system (e.g., a frame, a support, etc.).

The arm assembly 68 of the bale wrap assembly transport system 66 is slidably coupled to the base 78 and configured to move with respect to a lateral axis 80 of the agricultural machine system between a retracted position and the illustrated extended position. As discussed in detail below, the arm assembly 68 is slidably coupled to the base 78 via track assemblies that enable the arm assembly 68 to move with respect to the lateral axis 80. Furthermore, as discussed in detail below, the arm assembly 68 is formed from multiple segments slidably coupled to one another.

In addition, the bale wrap assembly transport system 66 includes a clamp assembly 82 configured to selectively couple to each bale wrap assembly 64. In the illustrated embodiment, each bale wrap assembly 64 includes a shaft 84 and a bale wrap 58 disposed about the shaft to form a roll of the bale wrap. As discussed in detail below, the clamp assembly 82 includes a pair of engagement arms 86, and each engagement arm 86 is configured to engage a respective lateral end of the shaft 84 of the bale wrap assembly 64 to couple the bale wrap assembly 64 to the clamp assembly 82.

The bale wrap assembly transport system 66 also includes a winch assembly 88 coupled to the arm assembly 68 and to the clamp assembly 82. The winch assembly 88 is configured to lower the clamp assembly 82 to a first lowered position while the arm assembly 68 is in the illustrated extended position to enable the clamp assembly 82 to couple to a bale wrap assembly 64, to raise the clamp assembly 82 to the illustrated raised position while the arm assembly 68 is in the illustrated extended position and the clamp assembly 82 is coupled to the bale wrap assembly 64, and to lower the clamp assembly 82 to a second lowered position while the arm assembly 68 is in the retracted position to enable the clamp assembly 82 to release the bale wrap assembly 64 within the bale wrap assembly storage compartment 62. The bale wrap assembly transport system 66 enables the bale wrap assembly 64 to be moved from a position external to the storage compartment (e.g., on the ground, on a vehicle, on a pallet, etc.) to the storage compartment 62 by a single operator. As a result, the time associated with disposing the bale wrap assembly within the storage compartment may be significantly reduced (e.g., as compared to employing the assistance of a second operator to manually lift and move the bale wrap assembly to the storage compartment). While the bale wrap assembly transport system 66 is configured to deliver the bale wrap assembly 64 to the bale wrap assembly storage compartment 62 in the illustrated embodiment, in other embodiments (e.g., in embodiments in which the bale wrap assembly storage compartment is omitted), the bale wrap assembly transport system may be configured to deliver the bale wrap assembly to another desired location within the agricultural machine system (e.g., the bale wrap feeding assembly).

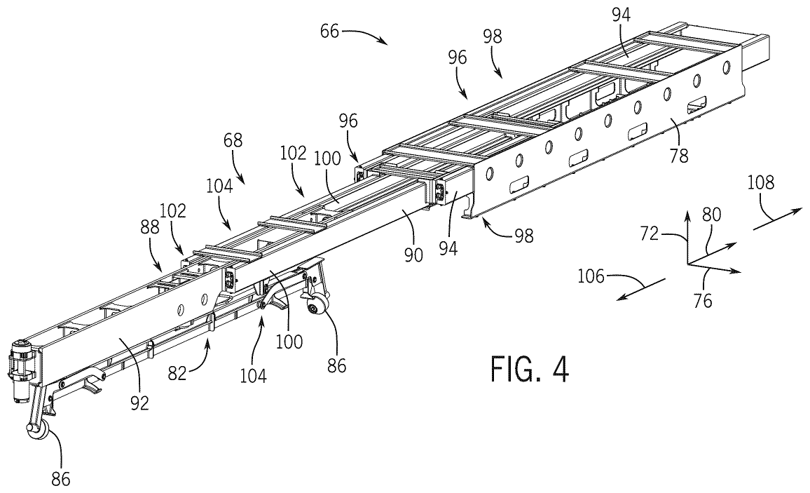

FIG. 4 is a perspective view of the bale wrap assembly transport system 66 of FIG. 3. In the illustrated embodiment, the arm assembly 68 includes a first segment 90 slidably coupled to the base 78, and the arm assembly 68 includes a second segment 92 slidably coupled to the first segment 90. In addition, the winch assembly 88 is coupled to the second segment 92 of the arm assembly 68. Furthermore, in the illustrated embodiment, tracks 94 are formed in the base 78, and wheels 96 are rotatably coupled to the first segment 90 of the arm assembly 68. The wheels 96 are engaged with the tracks 94, thereby forming track assemblies 98 that slidably couple the first segment 90 to the base 78. In addition, tracks 100 are formed in the first segment 90 of the arm assembly 68, and wheels 102 are rotatably coupled to the second segment 92 of the arm assembly 68. The wheels 102 are engaged with the tracks 100, thereby forming track assemblies 104 that slidably couple the second segment 92 to the first segment 90 of the arm assembly 68. Furthermore, the arm assembly 68 includes stops configured to limit movement of the first segment 90 relative to the base 78 along the lateral axis 80 and to limit movement of the second segment 92 relative to the first segment 90 along the lateral axis 80. Accordingly, the arm assembly 68 is configured to move in a first lateral direction 106 from the retracted position to the illustrated extended position (e.g., by telescoping), and the arm assembly 68 is configured to move in a second lateral direction 108 from the illustrated extended position to the retracted position (e.g., by telescoping).

In the illustrated embodiment, the arm assembly 68 is configured to be moved manually between the extended and retracted positions. For example, an operator may grasp the clamp assembly 82 and the pull arm assembly 68 in the first lateral direction 106 to the extended position, and the operator may grasp the clamp assembly 82 and push the arm assembly 68 in the second lateral direction 108 to the retracted position. In other embodiments, the bale wrap assembly transport system may include arm assembly actuator(s) (e.g., electric motor(s), hydraulic motor(s), hydraulic cylinder(s), electric linear actuator(s), etc.) configured to drive the arm assembly to move between the retracted and extended positions.

While the arm assembly 68 includes two segments in the illustrated embodiment, in other embodiments, the arm assembly may include more or fewer segments (e.g., 1, 3, 4, or more). For example, in certain embodiments, the arm assembly may include a single segment slidably coupled to the base and configured to move with respect to the lateral axis between the extended and retracted positions. In addition, while each segment is slidably coupled to another element (e.g., the base or another segment) by two track assemblies in the illustrated embodiment, in other embodiments, at least one segment may be coupled to the other element by more or fewer track assemblies (e.g., 1, 3, 4 or more). In addition, in certain embodiments, at least one segment may be coupled to the other element by other suitable assembly/assemblies (e.g., alone or in combination with one or more track assemblies) to enable movement of the segment with respect to the lateral axis, such as one or more slot and groove assemblies, one or more protrusion and recess assemblies, etc.

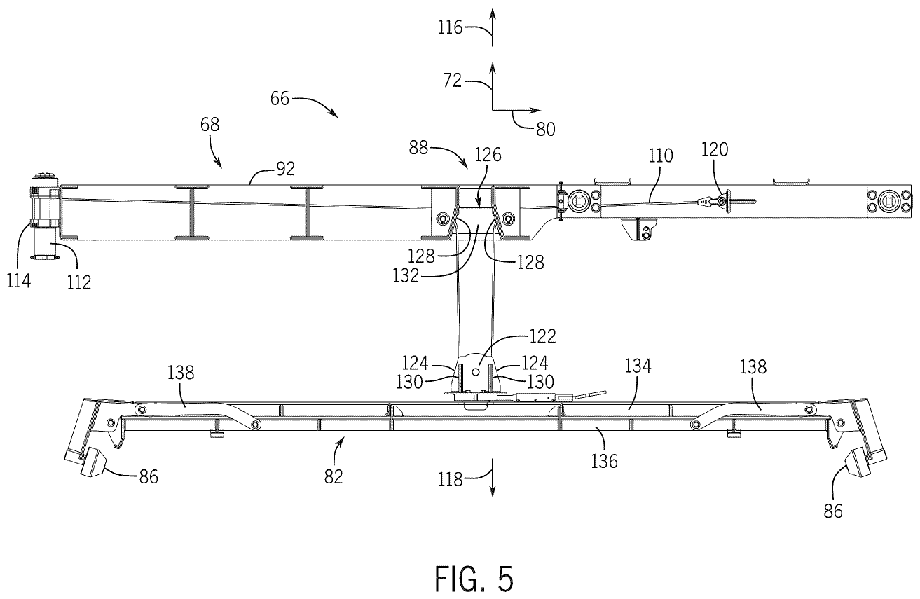

FIG. 5 is a front view of a portion of the bale wrap assembly transport system 66 of FIG. 3. In the illustrated embodiment, the winch assembly 88 includes a cable 110 coupled to the second segment 92 of the arm assembly 68, and the winch assembly 88 includes a motor 112 (e.g., winch motor) coupled to the cable 110 and to the second segment 92 of the arm assembly 68. As discussed in detail below, the winch assembly 88 includes a pair of arm pullies rotatably coupled to the second segment 92 of the arm assembly 68, and the winch assembly 88 includes a clamp pulley rotatably coupled to the clamp assembly 82. The cable 110 is engaged with the arm pullies and the clamp pulley. The motor 112 is configured to drive the cable 110 to wind around a spool 114, thereby driving the clamp assembly 82 to move in an upward vertical direction 116. In addition, the motor 112 is configured to enable the cable 110 to unwind from the spool 114, thereby enabling the clamp assembly 82 to move in a downward vertical direction 118 under the influence of gravity. The motor 112 may be coupled to the second segment 92 of the arm assembly 68 by any suitable type(s) of connection(s) (e.g., a welded connection, a fastener connection, a latched connection, an adhesive connection, other suitable type(s) of connection(s), or a combination thereof). Furthermore, the cable 110 is coupled to the second segment 92 of the arm assembly 68 via a mount 120. While the cable 110 and the motor 112 are coupled to the second segment 92 of the arm assembly 68 in the illustrated embodiment, in other embodiments, the cable and the motor may be coupled to another suitable segment of the arm assembly (e.g., the segment that extends farthest from the base).

Furthermore, in the illustrated embodiment, the clamp assembly 82 includes a pulley support 122 configured to support the clamp pulley of the winch assembly 88. The pulley support 122 includes angled lateral surfaces 124, which are angled laterally inward along the upward vertical direction 116. In addition, the second segment 92 of the arm assembly 68 includes a receiver 126 having angled lateral surfaces 128. The angle lateral surfaces 128 of the receiver 126 are also angled laterally inward along the upward vertical direction 116. The angled lateral surfaces 128 of the receiver 126 are configured to engage the angled lateral surfaces 124 of the pulley support 122 as the clamp assembly 82 moves to the raised position, thereby laterally aligning the pulley support 122 with the receiver 126. Laterally aligning the pulley support 122 with the receiver 126 laterally aligns the clamp assembly 82 with the second segment 92 of the arm assembly 68 and blocks lateral movement of the clamp assembly 82 with respect to the second segment 92 of the arm assembly 68 while the clamp assembly 82 is in the raised position. As a result, while the clamp assembly 82 is coupled to the bale wrap assembly, movement of the arm assembly 68 from the extended position to the retracted position drives movement of the bale wrap assembly through an inlet of the storage compartment.

In addition, in the illustrated embodiment, the pulley support 122 includes angled longitudinal surfaces 130, which are angled longitudinally inward along the upward vertical direction 116. The receiver 126 also has angled longitudinal surfaces 132, which are angled laterally inward along the upward vertical direction 116. The angled longitudinal surfaces 132 of the receiver 126 are configured to engage the angled longitudinal surfaces 130 of the pulley support 122 as the clamp assembly 82 moves to the raised position, thereby longitudinally aligning the pulley support 122 with the receiver 126. Longitudinally aligning the pulley support 122 with the receiver 126 longitudinally aligns the clamp assembly 82 with the second segment 92 of the arm assembly 68. As a result, while the clamp assembly 82 is coupled to the bale wrap assembly, the clamp assembly 82 is in the raised position, and the arm assembly 68 is in the retracted position, the bale wrap assembly may be lowered through the storage compartment.

While the receiver 126 is positioned at the second segment 92 of the arm assembly 68 in the illustrated embodiment, in other embodiments, the receiver may be positioned at another suitable segment of the arm assembly (e.g., the segment that extends farthest from the base). Furthermore, while the receiver 126 and the pulley support 122 include angled lateral surfaces and angled longitudinal surfaces in the illustrated embodiment, in other embodiments, the angled lateral surfaces and/or the angled longitudinal surfaces may be omitted. In addition, while the bale wrap transport assembly 66 includes the winch assembly 88 in the illustrated embodiment, in other embodiments, the winch assembly may be omitted, and the bale wrap assembly transport system may include another suitable assembly configured to selectively raise and lower the clamp assembly (e.g., scissor jack assembly, etc.).

As previously discussed, each engagement arm 86 of the clamp assembly 82 is configured to engage a respective lateral end of the shaft of the bale wrap assembly to couple the bale wrap assembly to the clamp assembly 82. Furthermore, in the illustrated embodiment, the clamp assembly 82 includes a support element 134, a contact element 136, and a pair of linkages 138. As discussed in detail below, the support element 134 is pivotally coupled to the pulley support 122, and the contact element 136 is configured to contact the bale wrap of the bale wrap assembly. As illustrated, each engagement arm 86 is pivotally coupled to the contact element 136. Furthermore, each linkage 138 is pivotally coupled to the contact element 136 at a first end of the linkage 138, and each linkage 138 is pivotally coupled to a respective engagement arm 86 and to the support element 134 at a second end of the linkage 138. At the pivotal coupling between the linkage 138, the engagement arm 86, and the support element 134, the linkage 138 includes a slot, and the engagement arm 86 includes a slot, thereby enabling the linkage 138 to pivot about the pivotal connection to the contact element 136 and enabling the engagement arm 86 to pivot about the pivotal connection to the contact element 136. The pair of linkages 138 is configured to drive the pair of engagement arms 86 to disengage the shaft of the bale wrap assembly in response to movement of the contact element 136 relative to the support element 134 in the upward vertical direction 116 toward a release position, and the pair of linkages 138 is configured to drive the pair of engagement arms 86 to engage the shaft of the bale wrap assembly in response to movement of the contact element 136 relative to the support element 134 in the downward vertical direction 118 away from the release position.

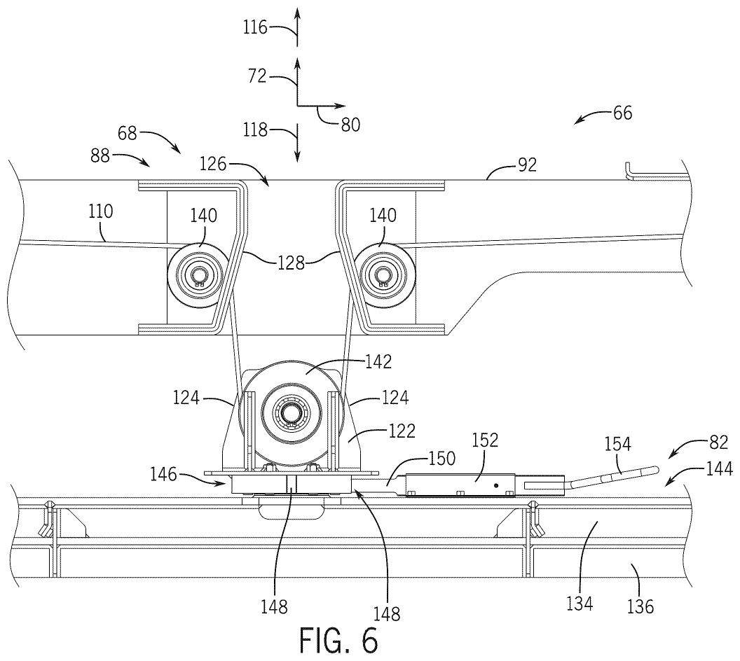

FIG. 6 is a front view of a portion of the bale wrap assembly transport system 66 of FIG. 3. As previously discussed, the winch assembly 88 includes a pair of arm pullies 140 rotatably coupled to the second segment 92 of the arm assembly 68. In addition, the winch assembly 88 includes a clamp pulley 142 rotatably coupled to the pulley support 122 of the clamp assembly 82. As illustrated, the cable 110 is engaged with the pair of arm pullies 140 and the clamp pulley 142. Furthermore, as previously discussed, the motor is configured to drive the cable 110 to wind around the spool to drive the clamp assembly 82 to move in the upward vertical direction 116, and the motor is configured to enable the cable 110 to unwind from the spool to enable the clamp assembly 82 to move in the downward vertical direction 118 under the influence of gravity. While the pair of arm pullies 140 is coupled to the second segment 92 of the arm assembly 68 in the illustrated embodiment, in other embodiments, the pair of arm pullies may be coupled to another suitable segment of the arm assembly (e.g., the segment that extends farthest from the base). In addition, while two pullies are rotatably coupled to the arm assembly in the illustrated embodiment, in other embodiments, more or fewer pullies may be rotatably coupled to the arm assembly (e.g., 1, 3, 4, or more). Furthermore, while one pulley is rotatably coupled to the clamp assembly in the illustrated embodiment, in other embodiments, more or fewer pullies may be coupled to the clamp assembly (e.g., 1, 3, 4, or more).

The support element 134, the contact element 136, the pair of linkages, and the pair of engagement arms form a clamp mechanism 144. In the illustrated embodiment, the clamp assembly 82 includes a pivot joint 146 coupled to the pulley support 122 and to the support element 134 of the clamp mechanism 144. The pivot joint 146 enables the clamp mechanism 144 to pivot about the vertical axis 72, or an axis parallel to the vertical axis, relative to the pulley support 122. The pivot joint 146 enables the clamp mechanism 144 to be aligned with the bale wrap assembly while the bale wrap assembly is at the position external to the storage compartment (e.g., on the ground, on a vehicle, on a pallet, etc.). For example, the clamp mechanism 144 may be rotated into alignment with the bale wrap assembly while the clamp assembly 82 is in the raised position. The clamp assembly 82 may then be lowered to the first lowered position to enable the clamp assembly 82 to couple to the bale wrap assembly. After the clamp assembly 82 is raised to the raised position, the clamp mechanism 144 may be rotated into alignment with the arm assembly 68, thereby facilitating movement of the arm assembly 68 to the retracted position.

In the illustrated embodiment, the pivot joint 146 includes multiple recesses 148 circumferentially distributed about the pivot joint 146. As illustrated, each recess 148 is formed in an outer circumferential surface of the pivot joint 146. In addition, the clamp assembly 82 includes a detent 150 configured to selectively engage each recess 148 to block rotation of the clamp mechanism 144 relative to the pulley support 122. In the illustrated embodiment, the pivot joint 146 includes four recesses 148, and the recesses 148 are equally spaced about the circumferential extent of the pivot joint 146 (e.g., the recesses are angularly offset by 90 degrees). However, in other embodiments, the pivot joint may include more or fewer recesses (e.g., 1, 2, 3, 5, 6, or more), and/or the recesses may be unequally spaced about the circumferential extent of the pivot joint. Furthermore, in the illustrated embodiment, the detent 150 is slidably coupled to a mount 152, and the mount 152 is coupled to the support element 134, thereby enabling the detent 150 to move with respect to the lateral axis 80 to selectively engage each recess 148. A biasing member (e.g., spring, pneumatic cylinder, etc.) is coupled to the detent 150 and to the mount 152, and the biasing member is configured to urge the detent into contact with the outer circumferential surface of the pivot joint 146. In addition, a handle 154 is coupled to the detent 150. Accordingly, to facilitate rotation of the clamp mechanism 144, the operator may grasp the handle 154 and drive the detent 150 to disengage a respective recess 148, and to block rotation of the clamp mechanism 144, the operator may release the handle 154, thereby enabling the detent to engage a respective recess 148 when the detent 150 is align with the recess 148 (e.g., as the clamp mechanism 144 rotates to a desired position).

While the handle 154 is coupled to the detent 150 in the illustrated embodiment, in other embodiments, the handle may be omitted. Furthermore, while the pivot joint 146 includes recesses 148 and the clamp assembly 82 includes the detent 150 in the illustrated embodiment, in other embodiments, the recesses and the detent may be omitted. For example, in certain embodiments, the clamp mechanism may include another suitable device configured to selectively block rotation of the clamp mechanism (e.g., a latch mechanism, a set screw, etc.). Furthermore, in certain embodiments, the clamp assembly may not include any device configured to selectively block rotation of the clamp mechanism. In addition, while the clamp assembly 82 includes the pivot joint 146 in the illustrated embodiment, in other embodiments, the pivot joint may be omitted, and the orientation of the clamp mechanism relative to the pulley support may be fixed (e.g., at least about the vertical axis or the axis parallel to the vertical axis).

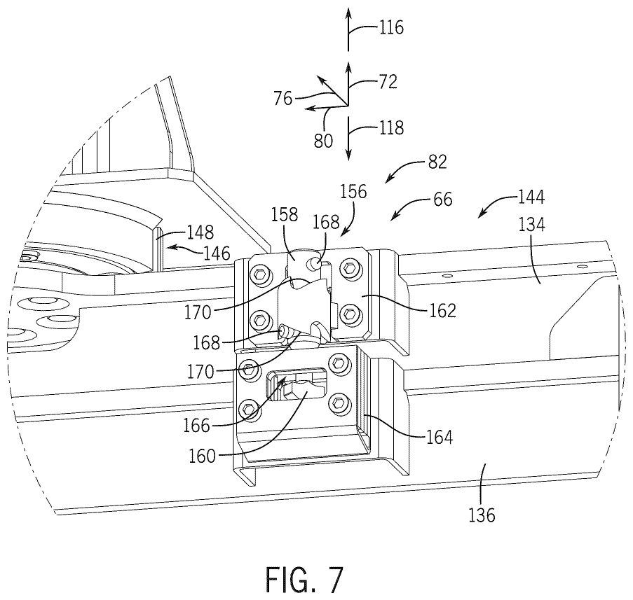

FIG. 7 is a perspective view of a portion of the bale wrap assembly transport system 66 of FIG. 3. In the illustrated embodiment, the clamp assembly 82 includes a locking mechanism 156 configured to hold the contact element 136 in the release position while engaged and to enable the contact element 136 to move in the downward vertical direction 118 away from the release position while disengaged. As previously discussed, the pair of linkages is configured to drive the pair of engagement arms to disengage the shaft of the bale wrap assembly in response to movement of the contact element 136 in the upward vertical direction 116 toward the release position, and the pair of linkages is configured to drive the pair of engagement arms to engage the shaft of the bale wrap assembly in response to movement of the contact element 136 in the downward vertical direction 118 away from the release position. Accordingly, while the locking mechanism 156 is engaged, the locking mechanism 156 holds the clamp assembly 82 in a released state with the engagement arms disengaged from the shaft of the bale wrap assembly. In addition, with the locking mechanism 156 disengaged, the clamp assembly 82 is enabled to transition to a coupled state in which the engagement arms are engaged with the shaft of the bale wrap assembly.

The locking mechanism 156 is configured to disengage in response to a first movement of the contact element 136 in the upward vertical direction 116 relative to the support element 134 beyond the release position, and the locking mechanism 156 is configured to engage in response to a second movement of the contact element 136 in the upward vertical direction 116 relative to the support element 134 beyond the release position. Accordingly, as discussed in detail below, the clamp assembly 82 may alternatingly transition between being held in the released state and being enabled to transition to the coupled state via repeated upward movement of the contact element 136 relative to the support element 134 beyond the release position. For example, the contact element may be engaged with the bale wrap of the bale wrap assembly to provide the upward movement of the contact element relative to the support element.

In the illustrated embodiment, the locking mechanism 156 includes a shaft 158 and a key 160 coupled to the shaft 158. In addition, the locking mechanism 156 includes a mount 162 coupled to the support element 134 (e.g., via the illustrated fastener connection), and the shaft 158 is rotatably coupled to the mount 162, such that the shaft 158 may rotate about the vertical axis 72 or an axis parallel to the vertical axis 72. Furthermore, the locking mechanism 156 includes a cage 164 coupled to the contact element 136 (e.g., via the illustrated fastener connection), and the cage 164 includes an opening 166. While the shaft 158 is in a locked orientation, movement of the contact element 136 in the downward vertical direction 118 away from the release position is blocked by contact between the key 160 and the cage 164. Furthermore, while the shaft 158 is in an unlocked orientation, the key 160 may pass through the opening 166, thereby enabling the contact element 136 to move in the downward vertical direction 118 relative to the support element 134 away from the release position. In the illustrated embodiment, multiple followers 168 are coupled to the shaft 158, and the mount 162 has multiple cam surfaces 170 configured to interface with the followers 168. The cam surfaces 170 and the followers 168 are configured to drive the shaft 158 to rotate between the locked orientation and the unlocked orientation in response to each upward and downward movement of the shaft 158.

In response to movement of the contact element 136 in the upward vertical direction 116 relative to the support element 134, contact between the key 160 and the cage 164 drives the shaft 158 to move in the upward vertical direction 116 relative to the mount 162. As a result of the upward movement of the shaft 158, contact between the lower followers 168 and the lower camp surface 170 drives the shaft 158 to rotate relative to the mount 162. In addition, while the key 160 is not aligned with the opening 166, in response to movement of the contact element 136 in the downward vertical direction 118 relative to the support element 134, contact between the key 160 and the cage 164 drives the shaft 158 to move in the downward vertical direction 118 relative to the mount 162. As a result of the downward movement of the shaft 158, contact between the upper followers 168 and the upper cam surface 170 drives the shaft 150 to rotate relative to the mount 162. Furthermore, while the key 160 is aligned with the opening 166, movement of the contact element 136 in the downward vertical direction 118 relative to the support element 134 is not blocked by contact between the key 160 and the cage 164. The cam surfaces 170 and the followers 168 are configured to cause the locking mechanism 156 to disengage in response to a first movement of the contact element 136 in the upward vertical direction 116 relative to the support element 134 beyond the release position, and to cause the locking mechanism 156 to engage in response to a second movement of the contact element 136 in the upward vertical direction 116 relative to the support element 134 beyond the release position.

While the clamp assembly 82 includes the locking mechanism 156 in the illustrated embodiment, in other embodiments, the locking mechanism may be omitted. For example, in certain embodiments, the contact element may be manually locked in the release position and in an engaged position, in which the pair of engagement arms are engaged with the shaft of the bale wrap assembly. Furthermore, in certain embodiments, the clamp assembly may include actuator(s) configured to drive the engagement arms to selectively engage and disengage the shaft of the bale wrap assembly. In addition, while the clamp assembly includes engagement arms configured to selectively engage the shaft of the bale wrap assembly in the illustrated embodiment, in certain embodiments, the engagement arms may be omitted, and the clamp assembly may include device(s) configured to engage the bale wrap of the bale wrap assembly (e.g., claw(s), strap(s), etc.).

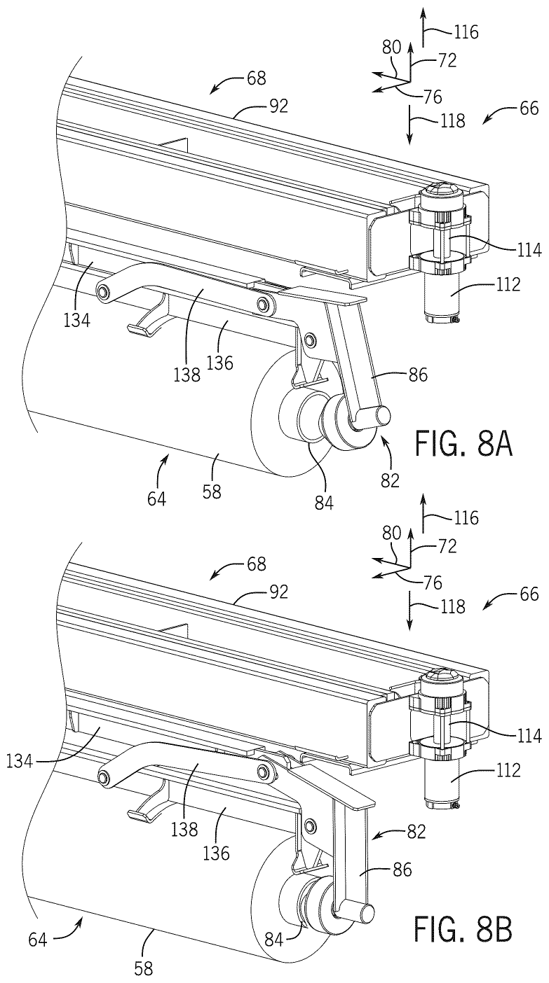

FIG. 8A is a perspective view of a portion of the bale wrap assembly transport system 66 of FIG. 3, in which the clamp assembly 82 is in the released state. To couple the bale wrap assembly 64 to the clamp assembly 82, the winch assembly lowers the clamp assembly 82 to the first lowered position while the arm assembly is in the extended position. Contact between the bale wrap 58 of the bale wrap assembly 64 and the contact element 136 drives the contact element 136 to move in the upward vertical direction 116 relative to the support element 134. In response to movement of the contact element 136 in the upward vertical direction 116 relative to the support element 134 beyond the release position, the locking mechanism disengages, thereby enabling the contact element to move in the downward vertical direction 118 away from the release position. Accordingly, as the winch assembly raises the clamp assembly 82 in the upward vertical direction 116, the contact element 136 moves in the downward vertical direction 118 relative to the support element 134. As a result, the pair of linkages 138 drive the pair of engagement arms 86 to engage the shaft 84 of the bale wrap assembly 64, which couples the bale wrap assembly 64 to the clamp assembly 82.

FIG. 8B is a perspective view of a portion of the bale wrap assembly transport system 66 of FIG. 3, in which the clamp assembly 82 is in the coupled state. To release the bale wrap assembly 64 from the clamp assembly 82 while the bale wrap assembly 64 is disposed within the bale wrap assembly storage compartment, the winch assembly lowers the clamp assembly 82 to the second lowered position while the arm assembly is in the retracted position. Contact between the bale wrap 58 of the bale wrap assembly 64 and the bale wrap assembly storage compartment or the bale wrap of another bale wrap assembly within the bale wrap assembly storage compartment drives the bale wrap 58 of the bale wrap assembly to contact the contact element 136, which drives the contact element 136 to move in the upward vertical direction 116 relative to the support element 134. In response to movement of the contact element 136 in the upward vertical direction 116 relative to the support element 134 to the release position, the pair of linkages 138 drive the pair of engagement arms 86 to disengage the shaft 84 of the bale wrap assembly 64, such that the clamp assembly 82 releases the bale wrap assembly 64. Further movement of the contact element 136 in the upward vertical direction 116 relative to the support element 134 beyond the release position causes the locking mechanism to engage, thereby holding the contact element 136 in the release position. Accordingly, the winch assembly may raise the clamp assembly 82 toward the raised position without the bale wrap assembly 64.

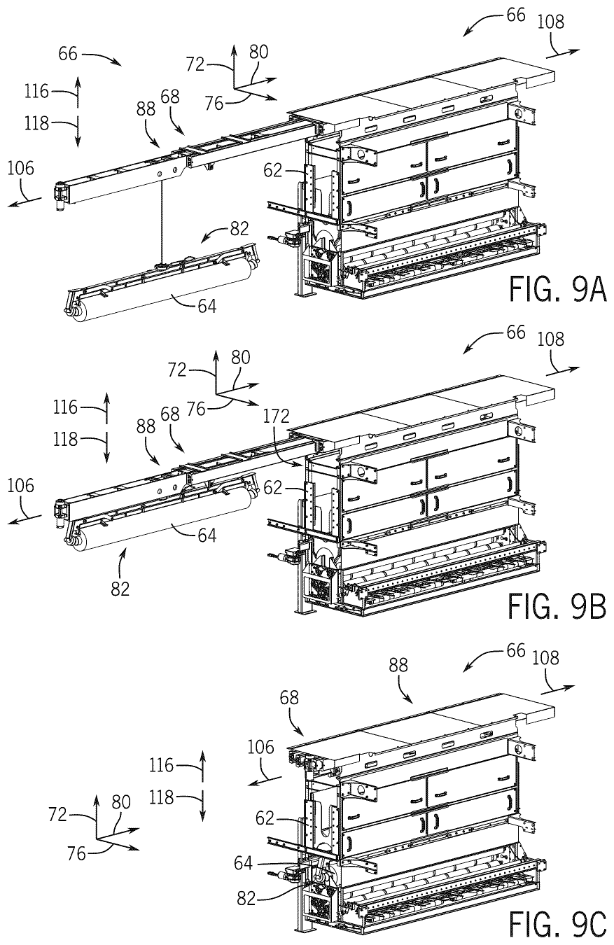

FIG. 9A is a perspective view of the bale wrap assembly transport system 66 of FIG. 3, in which the arm assembly 68 is in the extended position, and the clamp assembly 82 is in the first lowered position. To move the bale wrap assembly 64 from the position external to the bale wrap assembly storage compartment 62 (e.g., on the ground, on a vehicle, on a pallet, etc.), the arm assembly 68 is moved in the first lateral direction 106 from the retracted position to the illustrated extended position. Next, the winch assembly 88 lowers the clamp assembly 82 in the downward vertical direction 118 from the raised position to the illustrated first lowered position while the arm assembly 68 is in the illustrated extended position, thereby enabling the clamp assembly to couple to the bale wrap assembly 64. As used herein, the position of the clamp assembly 82 corresponds to the position of the support element of the clamp assembly. Furthermore, the first lowered position of the clamp assembly 82 may be selected based on the position of the bale wrap assembly 64 with respect to the vertical axis 72.

In certain embodiments, the bale wrap assembly 64 may not be aligned with the clamp assembly 82 while the bale wrap assembly is at the position external to the bale wrap assembly storage compartment 62. For example, the bale wrap assembly 64 (e.g., the rotational axis of the bale wrap assembly 64) may be aligned with the longitudinal axis 76 of the agricultural machine system. Accordingly, the clamp mechanism of the clamp assembly 82 may be rotated to align the clamp mechanism with the bale wrap assembly 64 before the clamp assembly 82 is lowered from the raised position to the first lowered position. As previously discussed, the detent may be disengaged from a respective recess to facilitate rotation of the clamp mechanism, and the detent may be engaged with a subsequent recess to block rotation of the clamp mechanism once the clamp mechanism is oriented at a desired angle relative to the pulley support.

As the clamp assembly 82 is lowered toward the illustrated first lowered position, the contact element of the clamp assembly 82 contacts the bale wrap of the bale wrap assembly 64. The contact element is driven in the upward vertical direction 116 relative to the support element beyond the release position as the clamp assembly 82 reaches the illustrated first lowered position, thereby disengaging the locking mechanism of the clamp assembly. As a result, movement of the contact element in the downward vertical direction 118 relative to the support element away from the release position is enabled. The winch assembly 88 then raises the clamp assembly 82 in the upward vertical direction 116, which causes the contact element to move in the downward vertical direction 118 relative to the support element 134 under the influence of gravity. As a result, the pair of linkages drives the pair of engagement arms to engage the shaft of the bale wrap assembly 64, which couples the bale wrap assembly 64 to the clamp assembly 82. The winch assembly 88 continues to raise the clamp assembly 82 in the upward vertical direction 116 to the raised position.

FIG. 9B is a perspective view of the bale wrap assembly transport system 66 of FIG. 3, in which the arm assembly 68 is in the extended position, and the clamp assembly 82 is in the raised position. In certain embodiments (e.g., in embodiments in which the bale wrap assembly is not aligned with the lateral axis of the agricultural machine system while the bale wrap assembly is at the position external to the bale wrap assembly storage compartment), the clamp mechanism of the clamp assembly 82 may be rotated to align the clamp mechanism with an inlet 172 of the bale wrap assembly storage compartment 62 (e.g., to align the rotational axis of the bale wrap assembly 64 with the lateral axis 80 of the agricultural machine system). In certain embodiments, the detent may be disengaged from a respective recess to facilitate rotation of the clamp mechanism, and the detent may be engaged with a subsequent recess to block rotation of the clamp mechanism once the clamp mechanism is oriented at a desired angle relative to the pulley support. To move the bale wrap assembly 64 through the inlet 172 of the bale wrap assembly storage compartment 62, the arm assembly 68 is moved in the second lateral direction 108 from the illustrated extended position to the retracted position.

FIG. 9C is a perspective view of the bale wrap assembly transport system 66 of FIG. 3, in which the arm assembly 68 is in the retracted position, and the clamp assembly 82 is in the second lowered position. After the arm assembly 68 is moved to the illustrated retracted position, the which assembly 88 lowers the clamp assembly 82 from the raised position to the illustrated second lowered position to enable the clamp assembly 82 to release the bale wrap assembly 64 within the bale wrap assembly storage compartment 62. The second lowered position of the clamp assembly 82 may be selected based on the position of a bottom of the bale wrap assembly storage compartment 62 or the highest bale wrap assembly within the bale wrap assembly storage compartment with respect to the vertical axis 72.

As the clamp assembly 82 is lowered toward the illustrated second lowered position, the contact element of the clamp assembly 82 contacts the bale wrap of the bale wrap assembly 64. Further movement of the clamp assembly 82 in the downward vertical direction 118 drives the contact element to move in the upward vertical direction 116 relative to the support element to the release position. Accordingly, the pair of linkages drives the pair of engagement arms to disengage the shaft of the bale wrap assembly 64, such that the clamp assembly 82 releases the bale wrap assembly 64. Further movement of the contact element in the upward vertical direction 116 relative to the support element beyond the release position causes the locking mechanism to engage as the clamp assembly 82 reaches the illustrated second lowered position. As a result, the locking mechanism holds the contact element in the release position. The winch assembly 88 then raises the clamp assembly 82 to the raised position without the bale wrap assembly 64.

In certain embodiments, the bale wrap assembly transport system includes a control panel positioned proximate to the bale wrap feeding assembly and configured to enable an operator located proximate to the bale wrap feeding assembly to access the control panel. The control panel includes controls configured to enable the operator to control each motor and actuator of the bale wrap assembly transport system. For example, the control panel may enable the operator to control the winch motor to raise and lower the clamp assembly. Furthermore, in embodiments having arm assembly actuator(s), the control panel may enable the operator to control the arm assembly actuator(s) to drive the arm assembly to move between the extended and retracted positions. In addition, in certain embodiments, the bale wrap assembly transport system may include clamp assembly rotation actuator(s) (e.g., electric motor(s), hydraulic motor(s), hydraulic cylinder(s), electric linear actuator(s), etc.) configured to drive the clamp mechanism to rotate relative to the pulley support. In such embodiments, the control panel may enable the operator to control the clamp assembly rotation actuator(s) to drive the clamp mechanism to rotate relative to the pulley support.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A bale wrap assembly transport system for an agricultural harvester, comprising:
a base configured to couple to a component of the agricultural harvester;
an arm assembly slidably coupled to the base and configured to move with respect to a lateral axis of the agricultural harvester between a retracted position and an extended position;
a clamp assembly configured to selectively couple to a bale wrap assembly; and
a winch assembly coupled to the arm assembly and to the clamp assembly;
wherein the winch assembly is configured to lower the clamp assembly to a first lowered position while the arm assembly is in the extended position to enable the clamp assembly to couple to the bale wrap assembly, to raise the clamp assembly to a raised position while the arm assembly is in the extended position and the clamp assembly is coupled to the bale wrap assembly, and to lower the clamp assembly to a second lowered position while the arm assembly is in the retracted position to enable the clamp assembly to release the bale wrap assembly at a desired location within the agricultural harvester.

2. The bale wrap assembly transport system of claim 1, wherein the arm assembly comprises:
a first segment slidably coupled to the base; and
a second segment slidably coupled to the first segment, wherein the winch assembly is coupled to the second segment of the arm assembly.

3. The bale wrap assembly transport system of claim 1, wherein the winch assembly comprises:
a cable coupled to the arm assembly;
a motor coupled to the cable and to the arm assembly;
a pair of arm pullies rotatably coupled to the arm assembly; and
a clamp pulley rotatably coupled to the clamp assembly;
wherein the cable is engaged with the pair of arm pullies and the clamp pulley.

4. The bale wrap assembly transport system of claim 1, wherein the clamp assembly comprises:
a pulley support configured to support a clamp pulley of the winch assembly;
a clamp mechanism; and
a pivot joint coupled to the pulley support and to the clamp mechanism, wherein the pivot joint enables the clamp mechanism to pivot relative to the pulley support.

5. The bale wrap assembly transport system of claim 4, wherein the pivot joint comprises a plurality of recesses circumferentially distributed about the pivot joint, and the clamp assembly comprises a detent configured to selectively engage each recess of the plurality of recesses to block rotation of the clamp mechanism relative to the pulley support.

6. The bale wrap assembly transport system of claim 1, wherein the clamp assembly comprises a pulley support having angled lateral surfaces, the pulley support is configured to support a clamp pulley of the winch assembly, the arm assembly comprises a receiver having angled lateral surfaces, and the angled lateral surfaces of the receiver are configured to engage the angled lateral surfaces of the pulley support as the clamp assembly moves to the raised position to laterally align the pulley support with the receiver.

7. The bale wrap assembly transport system of claim 1, wherein the clamp assembly comprises a pair of engagement arms, and each engagement arm of the pair of engagement arms is configured to engage a respective lateral end of a shaft of the bale wrap assembly to couple the bale wrap assembly to the clamp assembly.

8. The bale wrap assembly transport system of claim 7, wherein the clamp assembly comprises:
a contact element configured to contact the bale wrap assembly, wherein each engagement arm of the pair of engagement arms is pivotally coupled to the contact element;
a pair of linkages, wherein each linkage of the pair of linkages is pivotally coupled to the contact element and to a respective engagement arm of the pair of engagement arms, and the pair of linkages is configured to drive the pair of engagement arms to disengage the shaft of the bale wrap assembly in response to movement of the contact element toward a release position, and the pair of linkages is configured to drive the pair of engagement arms to engage the shaft of the bale wrap assembly in response to downward movement of the contact element away from the release position; and
a locking mechanism configured to hold the contact element in the release position while engaged and to enable the contact element to move downwardly away from the release position while disengaged, wherein the locking mechanism is configured to disengage in response to a first upward movement of the contact element beyond the release position, and the locking mechanism is configured to engage in response to a second upward movement of the contact element beyond the release position.

9. An agricultural harvester, comprising:
a bale wrap assembly storage compartment configured to store a plurality of bale wrap assemblies;
a bale wrap feeding assembly configured to receive an active bale wrap assembly of the plurality of bale wrap assemblies from the bale wrap assembly storage compartment; and
a bale wrap assembly transport system, comprising:
a base coupled to the bale wrap assembly storage compartment;
an arm assembly slidably coupled to the base and configured to move with respect to a lateral axis of the agricultural harvester between a retracted position and an extended position;
a clamp assembly configured to selectively couple to an additional bale wrap assembly of the plurality of bale wrap assemblies; and
a winch assembly coupled to the arm assembly and to the clamp assembly;
wherein the winch assembly is configured to lower the clamp assembly to a first lowered position while the arm assembly is in the extended position to enable the clamp assembly to couple to the additional bale wrap assembly, to raise the clamp assembly to a raised position while the arm assembly is in the extended position and the clamp assembly is coupled to the additional bale wrap assembly, and to lower the clamp assembly to a second lowered position while the arm assembly is in the retracted position to enable the clamp assembly to release the additional bale wrap assembly within the bale wrap assembly storage compartment.

10. The agricultural harvester of claim 9, wherein the winch assembly comprises:
a cable coupled to the arm assembly;
a motor coupled to the cable and to the arm assembly;
a pair of arm pullies rotatably coupled to the arm assembly; and
a clamp pulley rotatably coupled to the clamp assembly;
wherein the cable is engaged with the pair of arm pullies and the clamp pulley.

11. The agricultural harvester of claim 9, wherein the clamp assembly comprises:
a pulley support configured to support a clamp pulley of the winch assembly;
a clamp mechanism; and
a pivot joint coupled to the pulley support and to the clamp mechanism, wherein the pivot joint enables the clamp mechanism to pivot relative to the pulley support.

12. The agricultural harvester of claim 9, wherein the arm assembly comprises:
a first segment slidably coupled to the base; and
a second segment slidably coupled to the first segment, wherein the winch assembly is coupled to the second segment of the arm assembly.

13. The agricultural harvester of claim 9, wherein the clamp assembly comprises a pulley support having angled lateral surfaces, the pulley support is configured to support a clamp pulley of the winch assembly, the arm assembly comprises a receiver having angled lateral surfaces, and the angled lateral surfaces of the receiver are configured to engage the angled lateral surfaces of the pulley support as the clamp assembly moves to the raised position to laterally align the pulley support with the receiver.

14. The agricultural harvester of claim 9, wherein the clamp assembly comprises a pair of engagement arms, and each engagement arm of the pair of engagement arms is configured to engage a respective lateral end of a shaft of the additional bale wrap assembly to couple the additional bale wrap assembly to the clamp assembly.

15. The agricultural harvester of claim 14, wherein the clamp assembly comprises:
a contact element configured to contact the additional bale wrap assembly, wherein each engagement arm of the pair of engagement arms is pivotally coupled to the contact element;
a pair of linkages, wherein each linkage of the pair of linkages is pivotally coupled to the contact element and to a respective engagement arm of the pair of engagement arms, the pair of linkages is configured to drive the pair of engagement arms to disengage the shaft of the additional bale wrap assembly in response to upward movement of the contact element toward a release position, and the pair of linkages is configured to drive the pair of engagement arms to engage the shaft of the additional bale wrap assembly in response to downward movement of the contact element away from the release position; and
a locking mechanism configured to hold the contact element in the release position while engaged and to enable the contact element to move downwardly away from the release position while disengaged, wherein the locking mechanism is configured to disengage in response to a first upward movement of the contact element beyond the release position, and the locking mechanism is configured to engage in response to a second upward movement of the contact element beyond the release position.

16. A method of moving a bale wrap assembly into a bale wrap assembly storage compartment of an agricultural harvester, comprising:
moving an arm assembly from a retracted position to an extended position, wherein the arm assembly is slidably coupled to a base and configured to move with respect to a lateral axis of the agricultural harvester between the retracted and extended positions, and the base is configured to couple to the bale wrap assembly storage compartment;
lowering, via a winch assembly, a clamp assembly from a raised position to a first lowered position while the arm assembly is in the extended position to enable the clamp assembly to couple to the bale wrap assembly, wherein the clamp assembly is configured to selectively coupled to the bale wrap assembly, and the winch assembly is coupled to the arm assembly and to the clamp assembly;
raising, via the winch assembly, the clamp assembly from the first lowered position to the raised position while the arm assembly is in the extended position and the clamp assembly is coupled to the bale wrap assembly;
moving the arm assembly from the extended position to the retracted position; and
lowering, via the winch assembly, the clamp assembly from the raised position to a second lowered position while the arm assembly is in the retracted position to enable the clamp assembly to release the bale wrap assembly within the bale wrap assembly storage compartment.

17. The method of claim 16, comprising contacting the bale wrap assembly with a contact element of the clamp assembly as the clamp assembly is lowered toward the first lowered position, such that the contact element is driven upwardly beyond a release position as the clamp assembly reaches the first lowered position to disengage a locking mechanism of the clamp assembly;
wherein the clamp assembly comprises a pair of engagement arms, each engagement arm of the pair of engagement arms is configured to engage a respective lateral end of a shaft of the bale wrap assembly to couple the bale wrap assembly to the clamp assembly, each engagement arm of the pair of engagement arms is pivotally coupled to the contact element, the clamp assembly comprises a pair of linkages, each linkage of the pair of linkages is pivotally coupled to the contact element and to a respective engagement arm of the pair of engagement arms, the pair of linkages is configured to drive the pair of engagement arms to disengage the shaft of the bale wrap assembly in response to movement of the contact element toward the release position, the pair of linkages is configured to drive the pair of engagement arms to engage the shaft of the bale wrap assembly in response to downward movement of the contact element away from the release position, and the locking mechanism is configured to hold the contact element in the release position while engaged and to enable the contact element to move downwardly away from the release position while disengaged.

18. The method of claim 17, comprising contacting the bale wrap assembly with the contact element of the clamp assembly as the clamp assembly is lowered toward the second lowered position, such that the contact element is driven upwardly beyond the release position as the clamp assembly reaches the second lowered position to engage the locking mechanism of the clamp assembly.

19. The method of claim 16, wherein the clamp assembly comprises a pulley support having angled lateral surfaces, the pulley support is configured to support a clamp pulley of the winch assembly, the arm assembly comprises a receiver having angled lateral surfaces, and the angled lateral surfaces of the receiver are configured to engage the angled lateral surfaces of the pulley support as the clamp assembly moves to the raised position to laterally align the pulley support with the receiver.

20. The method of claim 16, comprising rotating a clamp mechanism of the clamp assembly to align the clamp mechanism with the bale wrap assembly before lowering the clamp assembly from the raised position to the first lowered position, wherein the clamp assembly comprises a pulley support configured to support a clamp pulley of the winch assembly, the clamp assembly comprises a pivot joint coupled to the pulley support and to the clamp mechanism, and the pivot joint enables the clamp mechanism to pivot relative to the pulley support.
